(19) United States
(12) Patent Application Publication
(10) Pub. No.: US 2013/0269239 A1
(43) Pub. Date: Oct. 17, 2013

(54) INSECT EXTERMINATION SYSTEM

(71) Applicants: John K. Whitley, Wilson, WY (US); Henry A. Palmer, York, SC (US); Daniel A. Baldwin, Oroville, CA (US); Noreen L. James, Titusville, FL (US); Ahmad K. Sleiti, Charlotte, NC (US); George E. Williams, Charlotte, NC (US)

(72) Inventors: John K. Whitley, Wilson, WY (US); Henry A. Palmer, York, SC (US); Daniel A. Baldwin, Oroville, CA (US); Noreen L. James, Titusville, FL (US); Ahmad K. Sleiti, Charlotte, NC (US); George E. Williams, Charlotte, NC (US)

(73) Assignee: The Steritech Group, Inc., Charlotte, NC (US)

(21) Appl. No.: 13/822,562

(22) PCT Filed: Sep. 13, 2011
(86) PCT No.: PCT/US2011/051378

§ 371 Date: Jun. 24, 2013

Related U.S. Application Data
(60) Provisional application No. 61/382,159, filed on Sep. 13, 2010.

(51) Int. Cl. A01M 1/20

(52) U.S. Cl. CPC A01M 1/2094
USPC 43/132.1

(57) ABSTRACT

Described herein are a system and method for treating bed bugs or other pests within an enclosure. The system comprises at least one heater, at least one fan, at least one temperature monitoring device, and a heat chamber. The method for use comprises sealing at least one heater, at least one fan, at least one temperature monitoring device, and articles for treatment into a heat chamber and heating the chamber to a temperature known to be lethal to the pests for an appropriate length of time.

### PRIORITY

This international, non-provisional application claims priority from a provisional application, U.S. Ser. No. 61/382,159, filed Sep. 13, 2010.

### BACKGROUND OF THE INVENTION

Bed bugs are small parasitic insects that feed exclusively on the blood of warm-blooded animals. While they can be found individually, they often congregate once established. They prefer to remain in areas close to hosts, often in or near beds or couches but also in luggage or furniture. They are generally nocturnal and prefer resting in dark crevices. Females usually lay 2-3 eggs per day and most reach an average of 200-500 eggs in their lifespan. Eggs usually hatch after 10 days but may take as long as 28 days before hatching. Some adults have been known to live without feeding for several months or possibly as much as a year, and nymphs, immature bed bugs, can live for up to four months without a meal. Their lifespan under ideal circumstances is about a year. Because of their habits and the fact that humans serving as hosts usually don't feel a bite, a bed bug infestation may go unnoticed for quite some time.

Bed bugs were nearly eradicated in the 1970s due to the use of DDT, which is now banned in the United States. Within the past decade or so, however, bed bugs have become a prevalent problem for many businesses and individuals. The hospitality industry has faced the biggest challenge. Hotels cannot do anything to prevent their guests from bringing the pests into their facilities, and sanitation has little to do with the establishment of bed bugs. This is a huge problem since guests may sue for damages and may also harm a business's reputation with negative reviews.

Several techniques for dealing with bed bugs have been developed over the years. A first attempt to eradicate the pests generally involves a thorough cleaning of the infected areas, including washing and drying any fabrics at high temperatures. Since the eggs are so small and generally hidden, this is often ineffective. Another option is to utilize one of the over 300 chemical treatments registered by the EPA for use against bed bugs. Unfortunately, the use of pesticides is not ideal for a number of reasons. First, chemicals harmful to the pests are likely to be harmful to humans or animals who may be exposed to the treatments. Accordingly, places and items treated with pesticides should be removed from access or service until the opportunity for toxic effects have passed. In the alternative, the safest techniques involve placing the pesticide products where humans and animals will not come into contact with the products. Nothing has yet been discovered to attract bed bugs to such products since they are uninterested in anything except blood, and as already mentioned these pests are generally located only in places conveniently near to their potential hosts. It is, thus, unlikely that the pests will, on their own, find and expose themselves to the products. Second, many populations of bed bugs have become resistant to pesticides. Some products and application methods may even make the problem worse by aiding of the development of immunities within the exposed population of pests or by causing the bed bugs to disperse, thereby spreading the infestation. Accordingly, a non-chemical approach is preferable.

Fortunately, there are non-chemical approaches available. All insects, including bed bugs, have a temperature range within which they can thrive and survive. For bed bugs, development stops at temperatures above approximately 99 degrees Fahrenheit and below approximately 55 degrees Fahrenheit. Adult bed bugs die when temperatures of at least 113 degrees Fahrenheit are maintained for 90 minutes or below 23 degrees Fahrenheit for several days. Instant death occurs for adults at 118 degrees Fahrenheit and 122 degrees Fahrenheit for eggs. Since it is easier to heat items or rooms to these temperatures for the specified times rather than cool them for several days, the use of heated atmospheric air is perhaps the most preferred method for treating bed bugs. This eliminates or minimizes the use of pesticides. This provides a safer environment for anyone exposed to the room or treated items, allows the rooms and items to be immediately accessed upon treatment, and does not provide the opportunity for pesticide resistance. If the treated area or items can be sealed, this provides an additional advantage since the bed bugs cannot escape and spread the infestation.

U.S. Pat. No. 6,141,901 discloses a technique for treating pests using heated air. The method requires pumping heated outside air into the area to be treated for a period of time. The outside air is heated to at least 200 degrees Fahrenheit and pumped into the area until the temperature inside the area rises to a lethal temperature.

U.S. Pat. No. 6,588,140 discloses another technique for treating pests using heated air. This method teaches the placement of articles in an enclosure, which is then sealed with a flexible, heat-resistant material. Hot air is then pumped into the enclosure, killing the pests.

U.S. Pat. No. 6,327,812 also discloses a method for treating pests using heated air within an enclosure. Hot air produced outside the enclosure is pumped into the enclosure. Temperature-sensing probes are installed within the enclosure to ensure that a lethal temperature is reached.

U.S. Patent Application No. 2010/0071258 discloses yet another system for using heated air to exterminate pests. The system includes two heaters, at least one of which further comprises a fan; several temperature-sensing probes; and a data recorder to receive and record temperature readings from the probes.

### BRIEF DESCRIPTION OF THE INVENTION

The subject invention relates to a system, method, and kit for exterminating pests by thermal treatment of articles that may host bed bugs or other pests. Specifically, the articles to be treated are placed along with specific equipment in a heat chamber. The equipment in the chamber is used to heat the chamber to a temperature known to be lethal to the pests and monitor the temperature in the chamber to ensure the extermination of the pests.

### BRIEF DESCRIPTION OF DRAWINGS

FIG. 1 is an expanded view of the top, side, and end panels of an exemplary embodiment of the heat chamber.

FIG. 2 shows a hinged panel assembly used to construct the walls of the heat chamber.

FIG. 3 shows a portion of a hinged panel assembly used to construct the walls of the heat chamber.

FIG. 4 shows a truss used to support the top panels of the heat chamber.

FIG. 5 depicts a completely assembled heat chamber.

FIGS. 6A and 6B depict a disassembled heat chamber. FIG. 6A shows the disassembled heat chamber before it is packed into bags for transport, and FIG. 6B shows the disassembled heat chamber packed into bags.

FIG. 7 depicts a partially assembled heat chamber with some equipment and articles to be treated.

### DESCRIPTION OF THE INVENTION

The present invention is directed to a system and method for treating articles that are infested or potentially infested with pests. While this system and method is described with respect to the extermination of bed bugs, the system and method may be used to eliminate other insects or microorganisms.

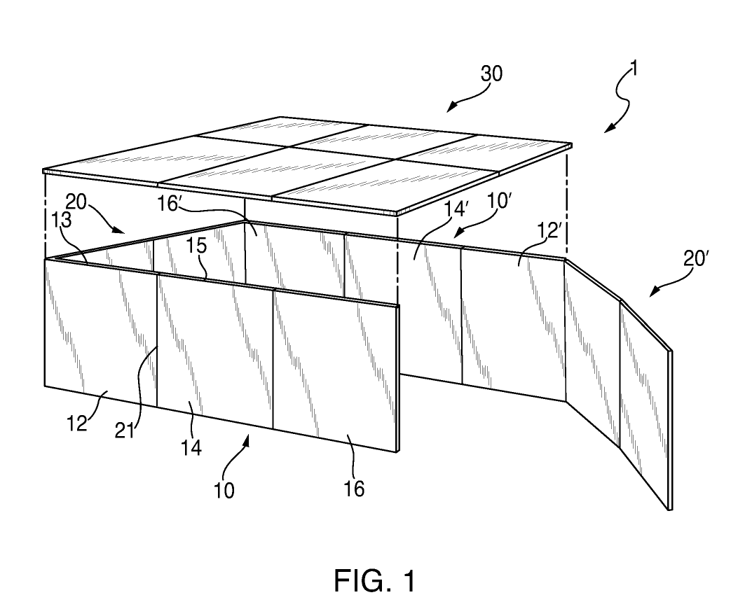

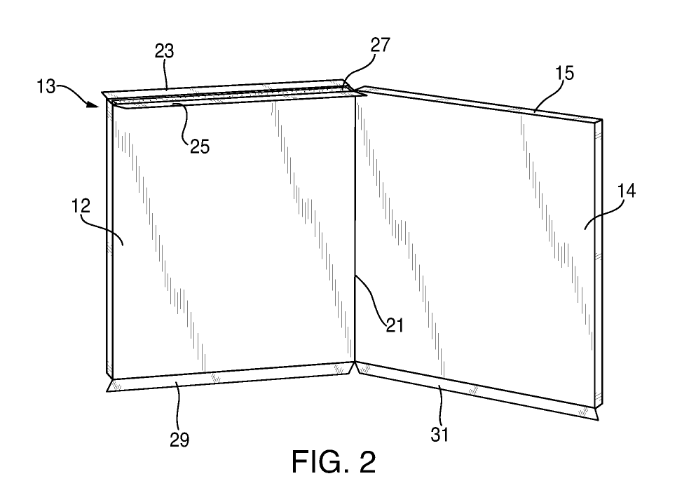

FIGS. 1-7 show aspects of the system according to an exemplary embodiment. FIG. 1 shows an exemplary embodiment of a complete heat chamber 1, not including the floor assembly. The chamber 1 consists of a pair of side panel assemblies 10, 10′; a pair of end panel assemblies 20, 20′; and a top panel assembly 30. As one skilled in the art will discern, the chamber 1 may be of any shape, such as square, triangular with three sides, round, or even pyramidal with a top formed by the intersection of the sides. Each assembly 10, 10′, 20, 20′, 30 is comprised of one or more panel sections. For example in the exemplary embodiment as shown in FIG. 1, the side panel assembly 10 is comprised of three panel sections 12, 14, 16. As shown in FIG. 2, the panel sections 12, 14, may be hinged at the seam 21 to allow for folding and ease of transportation, and to make solid seams when the panels 12, 14, are unfolded. It is contemplated that the sections of each assembly 10, 10′, 20, 20′, 30 would be manufactured of a durable, impermeable, and somewhat flexible material, such as a vinyl fabric. Such material will, when the chamber 1 is assembled such that the assemblies 10, 10′, 20, 20′, 30 form an enclosure, create a radiant barrier.

Each panel section, as shown in detail with respect to sections 12, 14 in FIG. 2, has an edge 13, 15. As shown with respect to section 12, the edge 13 is comprised of two flaps 23, 25, which can be opened to reveal an aperture into which an insulating support 27 may be inserted. The insulating support 27 may be comprised of any material suitable for this application, such as a thick rigid foam board like polystyrene, polyisocyanurate, or polyurethane, having a sufficient R-value so that the section 12 with the insulating support 27 inserted may act as a radiant barrier. The benefit of this design is that insulating support 27 may be removed and replaced if it becomes damaged, providing increased convenience and affordability over chambers without this feature. In certain embodiments, the flaps 23, 25 are further comprised of one or more fastening devices, such as hook and loop fasteners, snaps, zippers, or buttons. As one skilled in the art should discern, the insertion points for the insulating support 27 may be differently configured than as shown.

As shown in detail in FIG. 2 with respect to sections 12, 14, the sections of side and end panel assemblies 10, 10′, 20, 20′ may have flaps 29, 31 at the bottom edges of the sections 12, 13. These flaps 29, 31 will help to create a seal to more reduce air loss within the chamber 1. The flaps 29, 31 may be made of the same material as the panel assemblies 10, 10′, 20, 20′ or may be made of another appropriate materials, such as that used for door sweeps.

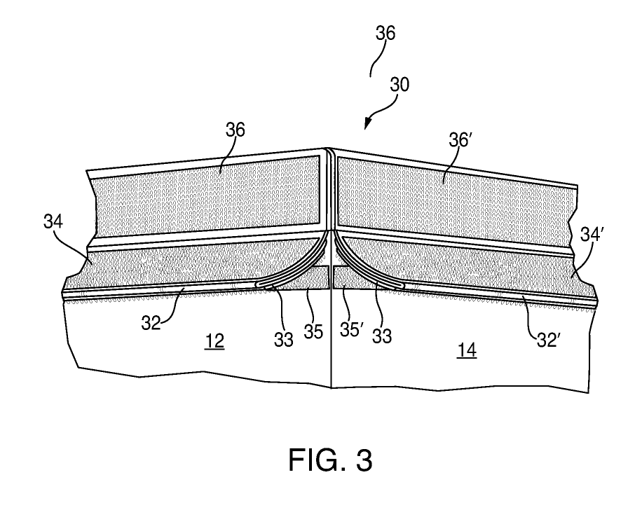

As shown in FIG. 3 with respect to sections 12, 14 and top panel assembly 30, there may be fastening devices, such as hook and loop fasteners, snaps, zippers, or buttons, at the edges of the sections 12, 14 and the top panel assembly 30 to secure the top panel assembly 30 to the sections 12, 14. The fastening devices may comprise a first and second mating component, with the first mating component disposed on a top portion of the panels forming the sides of the chamber. The second mating component may be disposed on a flap connected to an outer edge portion of the panels forming the top of the chamber or may be disposed on an outer edge portion of the panels forming the top of the chamber. In the exemplary embodiment shown, top panel assembly may have flaps 32, 32′ along its outer edges. As shown with respect to the flaps 32, 32′, the flaps 32, 32′ may have fastening devices 33, 33′ on the bottom side so that the top panel assembly 30 may be secured to the panels 12, 14 by folding down the flaps 32, 32′ and attaching the fastening devices 33, 33′ to the fastening devices 35, 35′ at the top portion of the panels 12, 14. This attachment provides structural support for the heat chamber 1 as well as providing for decreased air leakage and thus increased effectiveness of the radiant barrier created by the assemblies 10, 10′, 20, 20′, 30. As shown with respect to the flaps 32, 32′, the flaps 32, 32′ may have fastening devices 34, 34′ on the top side so that the flaps 32, 32′ may be tucked away for storage by attaching the fastening devices 34, 34′ to fastening devices 36, 36′ on the top panel assembly 30.

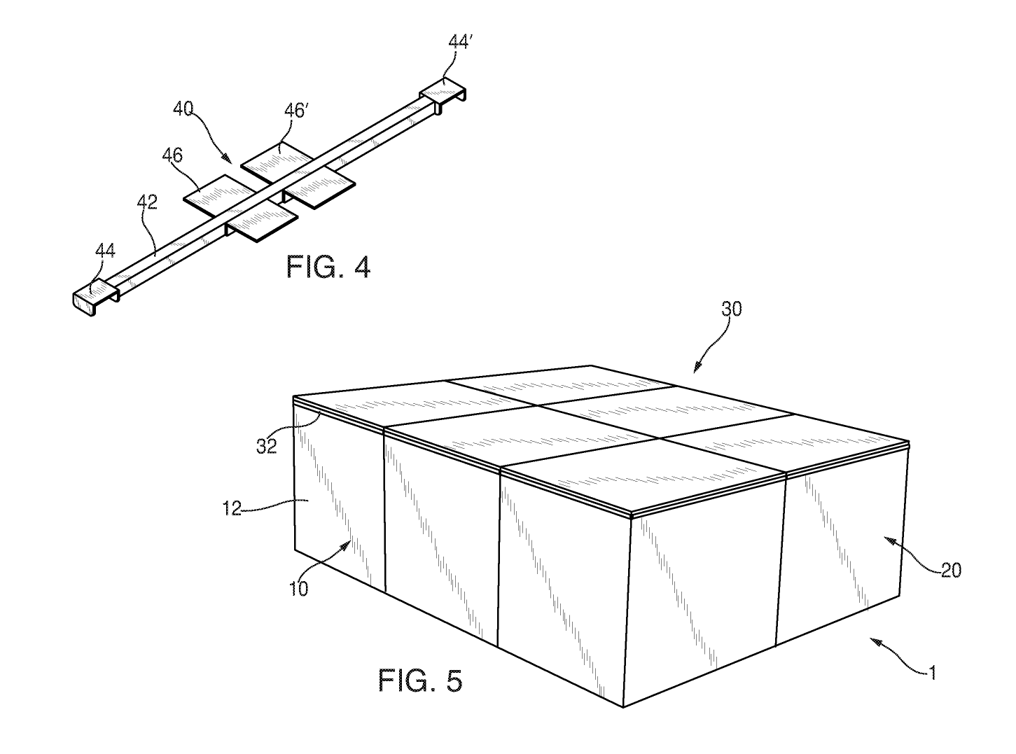

FIG. 4 shows a truss 40. When the heat chamber 1 is assembled, one or more trusses 40 may be used to prevent the top panel assembly 30 from sagging, allowing for a more airtight seal of the top panel assembly 30 to the side and end panel assemblies 10, 10′, 20, 20′. The exemplary truss 40 is comprised of a bar 42. The bar 42 has two end clamps 44, 44′, one at each proximal end. In the exemplary embodiment, the end clamps 44, 44′ are fixed and identically situated for such that the surfaces to be clamped will be parallel to each other. In the middle section of the bar 42 in the exemplary embodiment, there are two supports 46, 46′. When used to assemble the heat chamber 1, the bar 42 stretches the width of the chamber 1, with supports 46, 46′, supporting the top panel assembly, and end clamps 44, 44′ securing the truss 40 to the chamber 1 by clamping to the top edges of the side panel assemblies 10, 10′.

FIG. 5 shows the heat chamber 1 completely assembled. The top panel assembly 30 is secured to the side and end panel assemblies 10, 10′, 20, 20′ (10′ and 20′ not shown). As called out with respect to section 12, a flap 32 attached to the top panel assembly has been folded down and attached to section 12 such that the fastening device 33 (not shown) on the underside of the flap 32 is connected to the fastening device 35 (not shown) at the top portion of the panel 12. When fully assembled as depicted, the heat chamber 1 is sealed sufficiently for the interior to maintain a temperature lethal to bed bugs.

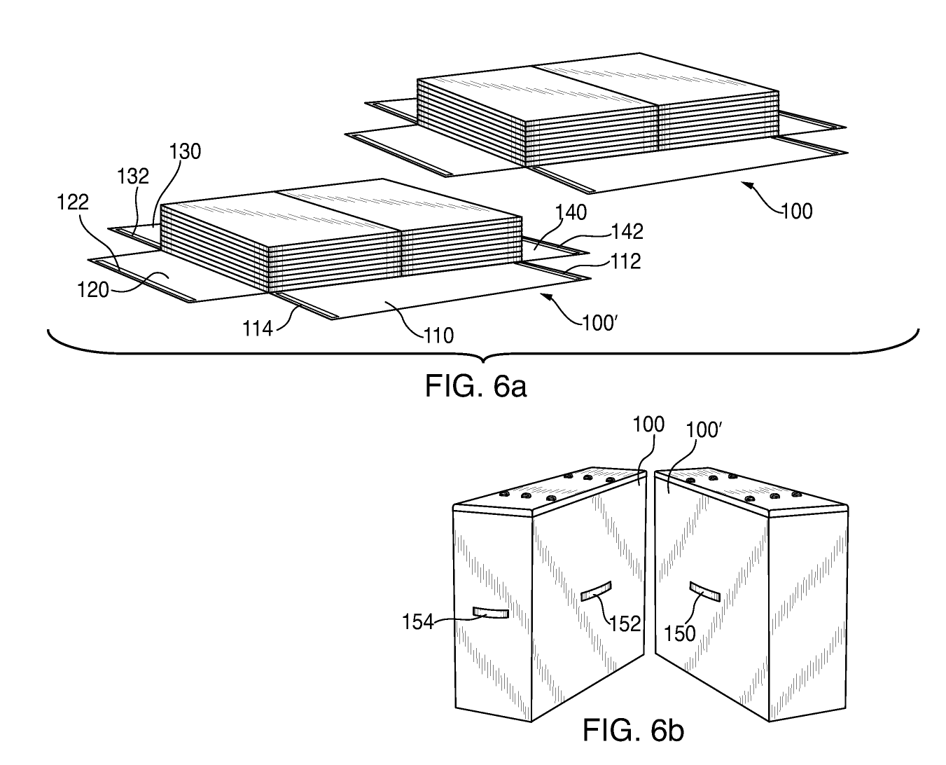

FIGS. 6A and 6B depict the heat chamber 1 completely disassembled. In FIG. 6A, each of the assemblies 10, 10′, 20, 20′, 30 has been broken down, folded, and stacked into two piles on top of unassembled carrying cases 100, 100′. As called out with respect to case 100′, the case 100′ is comprised of several sections 110, 120, 130, 140, portions of which are edged with fastening devices 112, 114, 122, 132, 142. The sections 110, 120, 130, 140, may be folded and secured with the 112, 114, 122, 132, 142, to envelop the assemblies 10, 10′, 20, 20′, 30. FIG. 6B depicts the assembled carrying cases 100, 100′, which may be equipped with handles 150, 152, 154. These carrying cases 100, 100′ provide an easy way to transport the heat chamber 1.

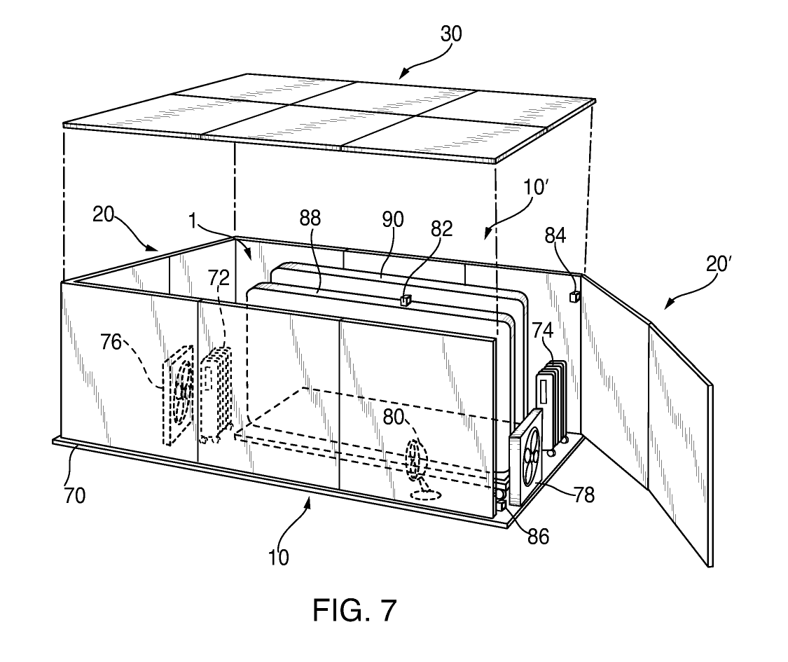

FIG. 7 depicts an assembled but unsealed heat chamber 1. The assemblies 10, 10′, 20, 20′ rest on a floor assembly 70, which is sized to match the footprint of the assembled side and end panel assemblies 10, 10′, 20, 20′. The floor assembly 70 may be comprised of any number of heat-reflective materials designed to act as thermal insulation. In an exemplary embodiment, the floor assembly 70 is comprised of rigid insulated foam panels with an aluminum foil backing glued to masonite board. The masonite board prevents items being placed on the assembly 70 from puncturing the foam panels. The inclusion of the floor assembly 70 as part of the heat chamber 1 provides additional support and avoids the possibility of structural damage to the building within which the treatment is being done. The assembly 70 also serves to reflect and contain heat, making easier the maintenance of a particular temperature within the chamber 1.

Inside the heat chamber 1, a user may place one or more heaters 72, 74, one or more fans 76, 78, 80, and one or more temperature monitoring devices 82, 84, 86. The heaters 72, 74 may be of any type, though electric heaters are likely to be more convenient. The fans 76, 78, 80 may also be of any type. In the exemplary embodiment, two fans 76, 78 are box fans and one fan 80 is an oscillating fan. Any number and type of temperature monitoring devices may be used. In the exemplary embodiment, the temperature monitoring devices are three digital thermometers 82, 84, 86, each having the capability of transmitting their temperature readings to a user outside the chamber 1. This allows for temperature readings to be quickly obtained and monitored in three different areas within the chamber 1.

Convection is a major benefit to the inventive system and method in that it facilitates heat transfer to infested items in an efficient manner. To maximize the convection effect, items, such as a mattress 88 and boxspring 90, may be placed in the heat chamber 1 and stacked in such a manner as to allow for maximum airflow. To increase the convective effect, the fans 76, 78, 80 circulate the heat output by the heaters 72, 74. In the exemplary embodiment, three digital thermometers 82, 84, 86 are placed throughout the chamber 1—one 82 in the upper portion of the chamber 1, one 84 in the lower portion, and one 86 within or on the densest item, such as the mattress 88.

Once the items are arranged within the chamber 1, the heaters 72, 74 and fans 76, 78, 80 are turned on. A user may set the fan speed to the lowest setting to minimize cooling. Once all three thermometers 82, 84, 86 read at least the desired temperature, a user may turn off the heaters 72, 74. The insulation provided by the top, side, and end assemblies 10, 10′, 20, 20′, 30 should be sufficient to maintain the internal temperature at or above the desired temperature for some time. Though adult bed bugs die at temperatures greater than 113 degrees Fahrenheit in 90 minutes and instantly at temperatures greater than 118 degrees Fahrenheit, it may be preferable to obtain a higher temperature to account for any variances in the temperature sensing devices and/or to ensure that the eggs as well as the adult bugs have been killed. For example, the chamber 1 may be heated to at least 120 degrees Fahrenheit and maintained at this level for 60 minutes, which will kill the adult bugs as well as the eggs. After this time, the heat chamber 1 may be disassembled since heat exposure for that length of time will be sufficient to kill the bugs and their eggs.

While certain specific relationships, materials and other parameters have been detailed in the above description of preferred embodiments, those can be varied, where suitable, with similar results. Other applications, variations, and ramifications of the present invention will be obvious to those skilled in the art upon reading the present disclosure. Those are intended to be included within the scope of this invention as defined in the claims.

1. A portable heat chamber system for pest extermination comprising
a. a portable heat chamber comprising:
i. panels sufficient to form an enclosure capable of being substantially completely closed,
ii. at least one fastening device capable of removably attaching at least one of the panels to another of the panels, and
iii. at least one truss capable of supporting at least a portion of the chamber so as to prevent collapse of the enclosure;
b. at least one heater,
c. at least one fan, and
d. at least one temperature monitoring device.

2. The portable heat chamber system of claim 1 wherein the panels of the enclosure comprise at least a top, a bottom, and sides of the enclosure.

3. The portable heat chamber system of claim 1 wherein
a. at least one panel comprising the enclosure further comprises an aperture, and wherein
b. the chamber further comprises at least one insulating support, the support being sized to fit through the aperture and within the panel.

4. The portable heat chamber system of claim 3 wherein at least one of the insulating supports comprises a rigid foam board constructed at least in part of material selected from the group consisting of polystyrene, polyisocyanurate, or polyurethane.

5. The portable heat chamber system of claim 1 wherein the panels forming the bottom of the chamber comprise at least in part a heat-reflective material.

6. The portable heat chamber system of claim 1 wherein the at least one fastening device comprises a fastener selected from the group consisting of hook and loop fasteners, zippers, snaps, and buttons.

7. The portable heat chamber system of claim 1 wherein the fastening device comprises a first and second mating component; said first mating component disposed on a top portion of the panels forming the sides of the chamber; and said second mating component disposed on a flap connected to an outer edge portion of the panels forming the top of the chamber.

8. The portable heat chamber system of claim 1 wherein the fastening device comprises a first and second mating component; said first mating component disposed on a flap connected to a top portion of the panels forming the sides of the chamber; and said second mating component disposed on an outer edge portion of the panels forming the top of the chamber.

9. The portable heat chamber system of claim 1 wherein the at least one fan is an oscillating fan and the system further comprises at least two box fans.

10. The portable heat chamber system of claim 1 wherein the at least one temperature monitoring device is a digital thermometer capable of transmitting temperature readings to a user outside the chamber.

11. A method for pest extermination comprising
a. erecting a heat chamber, said heat chamber comprising
i. panels sufficient to form an enclosure capable of being substantially completely closed,
ii. at least one fastening device capable of removably attaching at least one of the panels to another of the panels, and
iii. at least one truss capable of supporting at least a portion of the chamber so as to prevent collapse of the enclosure;
b. sealing at least one heater, at least one fan, at least one temperature monitoring device, and at least one article for treatment into the heat chamber; and
c. heating the chamber to a temperature known to be lethal to pests for an appropriate length of time.

12. The method for pest extermination of claim 11 wherein the chamber is heated to at least 113 degrees Fahrenheit and left sealed for at least ninety minutes.

13. The method for pest extermination of claim 11 wherein the chamber is heated to at least 120 degrees Fahrenheit and left sealed for at least one hour.
